(19) United States
(12) Patent Application Publication
(10) Pub. No.: US 2026/0099195 A1
(43) Pub. Date: Apr. 9, 2026

(54) DISPLAY DEVICE FOR PROVIDING VIRTUAL OBJECT THROUGH MIRROR DISPLAY AND CONTROL METHOD THEREOF

(71) Applicant: SAMSUNG ELECTRONICS CO., LTD., Suwon-si (KR)

(72) Inventors: Yongseok JANG, Suwon-si (KR); Dongyoon KIM, Suwon-si (KR); Kisung LEE, Suwon-si (KR)

(73) Assignee: SAMSUNG ELECTRONICS CO., LTD., Suwon-si (KR)

(21) Appl. No.: 19/406,111

(22) Filed: Dec. 2, 2025

Related U.S. Application Data
(63) Continuation of application No. PCT/KR2024/008880, filed on Jun. 26, 2024.

(30) Foreign Application Priority Data
Aug. 1, 2023 (KR) 10-2023-0100514
Sep. 27, 2023 (KR) 10-2023-0131056

(51) Int. Cl. G06F 3/01; G06T 7/521; G06T 7/68; G06T 11/00

(52) U.S. Cl. CPC G06F 3/011; G06F 3/016; G06T 7/521; G06T 7/68; G06T 11/00; G06T 2200/24; G06T 2207/10028; G06T 2207/20084; G06T 2207/30196

(57) ABSTRACT

A display device includes: a mirror display; a depth camera configured to capture an image of an object reflected on the mirror display; memory storing instructions; and one or more processors, wherein the instructions, when executed by the one or more processors individually or collectively, cause the display device to: obtain the image of the object through the depth camera and obtain depth information of the object, obtain, based on the depth information of the object, skeleton information of the object, obtain, based on the skeleton information, shape information of the object, and match, based on the shape information of the object and virtual shape information of a virtual object, the virtual object to the object and display the virtual object, as matched to the object, through the mirror display.

### CROSS-REFERENCE TO RELATED APPLICATIONS

This application is a continuation of International Application No. PCT/KR2024/008880, filed on Jun. 26, 2024, which is based on and claims priority to Korean Patent Application No. 10-2023-0100514, filed on Aug. 1, 2023, in the Korean Intellectual Property Office, and Korean Patent Application No. 10-2023-0131056, filed on Sep. 27, 2023, in the Korean Intellectual Property Office, the disclosures of which are incorporated by reference herein in their entireties.

### BACKGROUND

### 1. Field

The disclosure relates to a display device and a control method thereof, and more particularly, to a display device providing a virtual object through a mirror display and a control method thereof.

### 2. Description of Related Art

With the advancement in the electronic technologies, various types of electronic apparatuses have been developed and supplied. In particular, various types of electronic apparatuses in addition to a television (TV) are currently used in ordinary households. Such electronic apparatuses are provided with a growing number of functions according to user demands.

For example, various types of services may be provided to users through a mirror display providing both of the mirror function and display function. The mirror display may display a virtual object with which a user can interact, while reflecting the user.

However, a conventional mirror display may not display a virtual object in a realistic manner considering the shape of a user. For example, in the conventional mirror display, the virtual object overlaps a mirror image corresponding to the user or penetrates the mirror image corresponding to the user, and the like. Accordingly, there are limitations in producing the effect of allowing the user to feel like the virtual object is placed in the same space as the space where the user is placed and the virtual object is an image reflected in the mirror.

There is a demand for a method of identifying, in a 3D, a mirror image corresponding to a user reflected on a mirror display and producing the effect of allowing a virtual object to be felt like an image reflected on the mirror display.

### SUMMARY

According to an aspect of the disclosure, a display device includes: a mirror display; a depth camera configured to capture an image of an object reflected on the mirror display; memory storing instructions; and one or more processors, wherein the instructions, when executed by the one or more processors individually or collectively, cause the display device to: obtain the image of the object through the depth camera and obtain depth information of the object, obtain, based on the depth information of the object, skeleton information of the object, obtain, based on the skeleton information, shape information of the object, and match, based on the shape information of the object and virtual shape information of a virtual object, the virtual object to the object and display the virtual object, as matched to the object, through the mirror display.

The skeleton information of the object represents a skeleton of each of a plurality of portions included in the object, and the instructions, when executed by the one or more processors individually or collectively, may cause the display device to: identify, based on a symmetrical structure with respect to the skeleton of each of the plurality of portions, a shape of each of the plurality of portions, and obtain the shape information of the object based on obtaining a shape of each of the plurality of portions.

The instructions, when executed by the one or more processors individually or collectively, may cause the display device to input the image to a neural network model and obtain, from the neural network model, the shape information of the object included in the image, and the neural network model is a model trained to output, based on the image including the object being input, the shape information of the object as including the depth information and with the depth information corresponding to each of a plurality of viewpoints with respect to the object.

The instructions, when executed by the one or more processors individually or collectively, may cause the display device to place, in the display of the object and based on the shape information of the object and the virtual shape information of the virtual object, a part of the virtual object in front of the object and a remainder of the virtual object behind the object.

The instructions, when executed by the one or more processors individually or collectively, may cause the display device to display, based on the shape information of the object and the virtual shape information of the virtual object, the virtual object in a way that a part of the virtual object contacts, in the display as output through the mirror display, the object.

The display device may further include a communication interface, and the instructions, when executed by the one or more processors individually or collectively, may cause the display device to: control the communication interface to communicate with a wearable device worn by the object, and control, based on identifying that the part of the virtual object contacts an area of the object in the display output through the mirror display, the wearable device to provide a tactile feedback to the area of the object.

The display device may further include a communication interface; and the instructions, when executed by the one or more processors individually or collectively, may cause the display device to: receive, from an external device and through the communication interface, the virtual shape information of the virtual object, and control the communication interface to transmit the shape information of the object to the external device.

The the instructions, when executed by the one or more processors individually or collectively, cause the display device to: perform, based on an input of a user with respect to the virtual object being identified, an interaction with the virtual object according to the input, transmit, to the external device and based on the input of the user, changed shape information of the object, and the input of the user may include a touch input with respect to a part of the virtual object.

The instructions, when executed by the one or more processors individually or collectively, may cause the display device to re-match, based on further changed shape information of the virtual object being received from the external device and according to a second input of a second user with respect to the object, the virtual object to the object, the virtual object corresponds to the second user as reflected on a second mirror display of the external device, and the object corresponds to the user.

The instructions, when executed by the one or more processors individually or collectively, may cause the display device to adjust, based on an input of a user, at least one of a position, a viewpoint, a size, or a ratio of the virtual object on the mirror display.

According to an aspect of the disclosure, a control method of a display device including a mirror display, includes: obtaining an image of an object, that is reflected on the mirror display, and depth information of the object; obtaining, based on the depth information of the object, skeleton information of the object; obtaining, based on the skeleton information, shape information of the object; and matching, based on the shape information of the object and virtual shape information of a virtual object, the virtual object to the object and displaying of the virtual object, as matched to the object, through the mirror display.

The skeleton information of the object may represent a skeleton of each of a plurality of portions included in the object, and the obtaining the shape information may include: identifying, based on a symmetrical structure with respect to the skeleton of each of the plurality of portions, a shape of each of the plurality of portions; and obtaining the shape information of the object based on obtaining shapes of each of the plurality of portions.

The obtaining the shape information may include inputting the image to a neural network model and obtaining, from the neural network model, the shape information of the object included in the image, and the neural network model is a model trained to output, based on the image including the object being input, the shape information of the object as including the depth information and with the depth information corresponding to each of a plurality of viewpoints with respect to the object.

The displaying of the virtual object, as matched to the object, through the mirror display may include placing, in the display of the object and based on the shape information of the object and the virtual shape information of the virtual object, a part of the virtual object in front of the object and a remainder of the virtual object behind the object.

The displaying of the virtual object, as matched to the object, through the mirror display may include displaying, based on the shape information of the object and the virtual shape information of the virtual object, the virtual object in a way that a part of the virtual object contacts, in the display as output through the mirror display, the object.

According to an aspect of the disclosure, a non-transitory computer readable medium stores a program configured to may cause one or more processors to implement a control method of a display device including a mirror display, the control method including: obtaining an image of an object, that is reflected on the mirror display, and depth information of the object; obtaining, based on the depth information of the object, skeleton information of the object; obtaining, based on the skeleton information, shape information of the object; and matching, based on the shape information of the object and virtual shape information of a virtual object, the virtual object to the object and displaying the virtual object, as matched to the object, through the mirror display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an attribute of a mirror display according to one or more embodiments;

FIG. 2 is a block diagram illustrating a configuration of a display device according to one or more embodiments;

FIGS. 3 and 4 are views provided to explain operations of a switchable mirror according to one or more embodiments;

FIG. 5 is a view provided to explain a display device providing an object and a virtual object according to one or more embodiments;

FIG. 6 is a view provided to explain depth information according to one or more embodiments;

FIG. 7 is a view provided to explain a display device obtaining shape information based on skeleton information according to one or more embodiments;

FIG. 8 is a view provided to explain a neural network model obtaining shape information according to one or more embodiments;

FIG. 9 is a view provided to explain a display device communicating with an external device according to one or more embodiments;

FIG. 10 is a view provided to explain a virtual object matched to an object according to one or more embodiments;

FIG. 11 is a view provided to explain a display device providing a feedback according to one or more embodiments;

FIG. 12 is a view provided to explain a display device communicating with an external device according to one or more embodiments; and

FIG. 13 is a flowchart provided to explain a control method of a display device according to one or more embodiments.

### DETAILED DESCRIPTION

Hereafter, the subject matter of the present disclosure is described in detail with reference to the accompanying drawings.

General terms currently used as widely as possible are selected as the terms used to describe the embodiments of the disclosure considering functions in the disclosure, but may be changed based on the intention of those skilled in the art or a judicial precedent, the emergence of a new technology, or the like. Additionally, in a certain case, terms arbitrarily chosen by the applicant may be included in the terms used herein. In this case, the meanings of such terms are described in detail in corresponding descriptions of the disclosure. Accordingly, the terms used in the disclosure need to be defined based on the meanings thereof and particulars throughout the disclosure rather than the names thereof.

In the disclosure, the expression “have”, “may have”, “include”, “may include” or the like, indicates the existence of a corresponding feature (e.g., a numerical value, a function, an operation or an element such as a part and the like), and does not exclude the existence of an additional feature.

The expression of “at least one of A or B” is to be understood as indicating, “A,” “B,” or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), it is to be understood that one element may be connected to another element directly, or through yet another element (e.g., a third element).

In the disclosure, singular forms include plural forms as well, unless explicitly indicated otherwise. In the disclosure, the term “include,” “comprised of” or the like specifies the presence of stated features, numbers, steps, operations, elements, components or combinations thereof, but does not imply the exclusion of the presence or addition of one or more other features, numbers, steps, operations, elements, components or combinations thereof.

In the disclosure, the term “module” or “unit” may perform at least one function or operation, and be implemented by hardware or software or by a combination of hardware and software. In addition, a plurality of “modules” or a plurality of “units” may be integrated into at least one module and be implemented by at least one processor (not illustrated) except for a “module” or a “unit” that needs to be implemented by specific hardware.

In the disclosure, the term user may refer to a person who uses an electronic apparatus or an apparatus (e.g., an artificial intelligence electronic apparatus) that uses an electronic apparatus.

Hereafter, one embodiment according to the disclosure is described in greater detail with reference to the accompanying drawings.

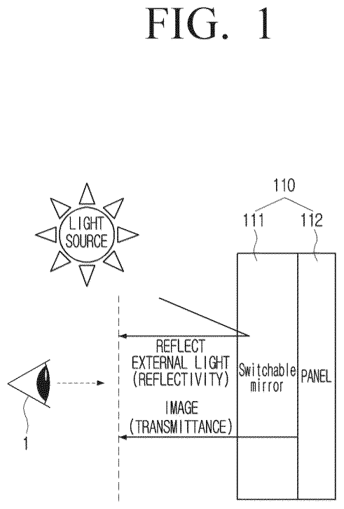

FIG. 1 is a view illustrating an attribute of a mirror display according to one or more embodiments.

A display device 100 according to one or more embodiments may be implemented as various types of mirror display devices that may be installed in various places where a mirror is required and deliver information while providing a mirror function. Herein, the “mirror display” is a compound word in which the word “mirror”, meaning a glass, and the word “display”, denoting a task of expressing information visually, are compound.

As illustrated in FIG. 1, the display device 100 may include a mirror display 110, and the mirror display 110 may include a switchable mirror 111, a display panel 112.

For example, the mirror display may include a display panel 112 that displays an image, and a switchable mirror 111 that is disposed on the front surface of the display panel 112 and of which reflectivity is adjustable.

As one example, to provide a mirror function, the switchable mirror 111 may be implemented as a glass plate or a transparent plastic plate on which a metal thin film or a dielectric multilayer film reflecting one portion of the amount of incident light and transmitting the other portion is deposited, to provide a mirror function.

As one example, the display panel 112 may include a display including a self light emitting element, or a non-self light emitting element and a backlight. For example, the display 112 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode (QLED) and the like.

In the disclosure, the position of the user 1, as illustrated in FIG. 1, is defined as the front surface of the display device 100 for convenience of description.

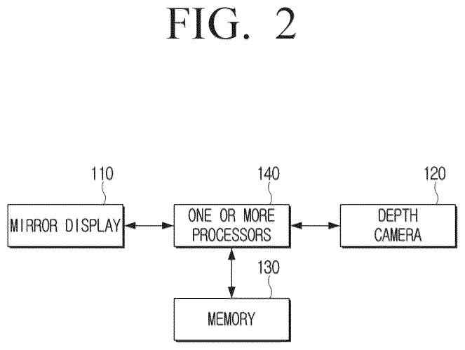

FIG. 2 is a block diagram illustrating a configuration of a display device according to one or more embodiments.

Referring to FIG. 2, the display device 100 includes a mirror display 110, a depth camera 120, memory 130 and one or more processors 140.

The mirror display 110 may be implemented as a display including a self light emitting element, or a display including a non-self light emitting element and a backlight. For example, the mirror display 110 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode (QLED) and the like.

In the mirror display 110, driving circuitry that is implementable in the form of an a-si TFT, a low temperature poly silicon (LTPS) TFT, an organic TFT (OTFT) and the like, a backlight unit and the like may be included together. As one example, a touch sensor formed into a touch film, a touch sheet, a touch pad and the like and configured to detect a touch operation may be disposed on the front surface of the mirror display 110 and implemented detect various types of touch inputs. For example, the mirror display 110 may detect various types of touch inputs such as a touch input caused by the user's hand, a touch input caused by an input device such as a stylus pen, a touch input caused by a specific electrostatic material, and the like. Herein, the input device may be implemented as a pen-type input device that may be referred to as various terms such as an electronic pen, a stylus pen, an S-pen and the like. As one example, the mirror display 110 may be implemented as a flat display, a curved display, a flexible display that is foldable or/and rollable, and the like.

Meanwhile, the mirror display 110 may be implemented as a display providing a mirror function and a display function.

For example, the mirror display 110 may be implemented in the way that a half mirror (or a mirror film) is added to an ordinary existing display panel. A display as an LCD including a half mirror which is one embodiment of the mirror display 110, and the LCD also referred to as a liquid crystal display operates in the way that as a backlight generates light, a desired image is obtained while the light is transmitted among molecules of liquid crystals.

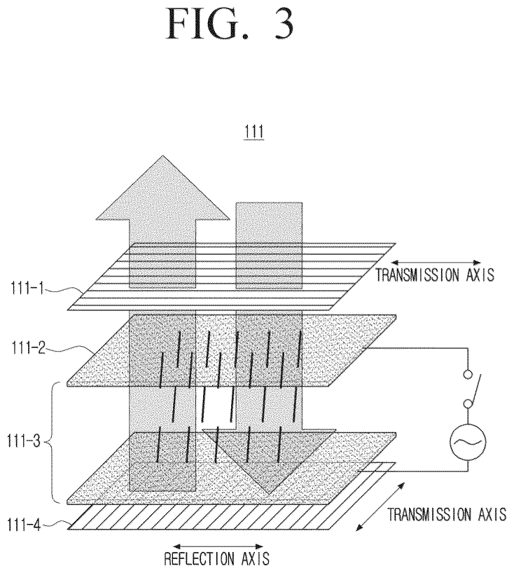

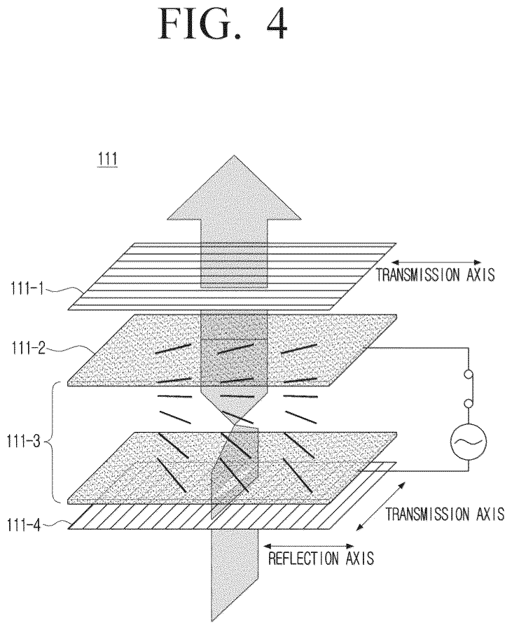

FIGS. 3 and 4 are views provided to explain operations of a switchable mirror according to one or more embodiments.

The switchable mirror 111 of one example may be implemented in the way that the switchable mirror 111 includes a polarizer, an upper glass, a lower glass, and a reflective polarizer.

As one example, a liquid crystal (LC) layer may be formed between the upper glass and the lower glass. Liquid crystals (LCs) in an intermediate state between a liquid and a crystal may have a structure in which rod-shaped molecules (liquid crystal molecules) are arranged in one direction like solid crystals.

As one example, the polarizer may be implemented to transmit polarized light. As one example, the upper glass and the lower glass may be implemented with transparent conductive oxide (TCO) glass but are not limited thereto.

FIG. 3 shows the switchable mirror 111 at a time of voltage off, and at a time when a voltage is off, liquid crystal molecules are maintained in a perpendicular state, and incident polarized light passes through a LC layer 111-3, as it is, and is reflected to the reflection axis of a reflective polarizer 111-5. Accordingly, the switchable mirror 111 may be maintained in a mirror state.

For example, since polarized light that is input at a time when electricity is not supplied is reflected to the reflection axis of the reflective polarizer, the switchable mirror 111 may provide a mirror function (hereafter, a mirror state), and since the input polarized light is rotated by 90 degrees and passes through the reflection axis of the reflective polarizer 111-5 at a time when electricity is supplied as illustrated in FIG. 4, the switchable mirror 111 may be maintained in a transparent state (hereafter, a clear state).

In addition, a protective film plying a role in protecting the polarizer, a film playing a role in classifying light on the polarizer and the like may be further included, depending on embodiments.

Referring back to FIG. 2, the depth camera 120 may be turned on based on a predetermined event to capture an image. The depth camera 120 may include a time of flight (ToF) camera sensor.

The ToF camera sensor may be a sensor that radiates a signal (e.g., near infrared light, ultrasonic waves, lasers and the like) and measures time from a moment when the radiated signal is reflected from a subject until a moment when the ToF camera sensor receives the reflected signal, to measure a distance (or depth) between the ToF camera sensor and the subject. As one example, the one or more processors 140 may obtain depth information of the subject based on the distance between the ToF camera sensor and the subject.

The ToF camera sensor is described as an example, and the depth camera 120 may not be limited thereto and may certainly include a Lidar sensor, a radar sensor, an ultrasonic sensor, an infrared sensor and the like.

Certainly, the display device 100 may include various types of cameras in addition to the depth camera 120. The camera of one example may convert a captured image to an electrical signal, and based on the converted signal, generate image data. For example, the camera may convert a subject to an electrical image signal through a semiconductor photonic device (a charge coupled device (CCD)), and amplify the converted image signal and convert the same to a digital signal, and then signal-process the digital signal. For example, the camera may include a normal camera (or a basic camera), an RGB camera or an ultra-wide angle camera.

The one or more processors 140 control the operations of the display device 100 entirely. Specifically, the one or more processors 140 may be connected with each of the elements of the display device 100 and control the operations of the display device 100 entirely.

For example, the one or more processors 140 may be electrically connected with the mirror display 110 and the memory 130 and control the entire operations of the display device 100. The one or more processors 140 may identify a distance between the ToF camera sensor and a subject through the depth camera 120, and based on the identified distance, may obtain depth information of the subject. The subject of one example may include a user placed on the front surface of the display device 100.

For example, the display device 100 may reflect the image of an object (or a user) placed on the front surface of the display device 100 based on a mirror function, and may obtain an image of the object as a subject through the depth camera 120. The image of one example may include a distance between the depth camera 120 and the subject, and the one or more processors 140 may obtain depth information of the subject based on the image. Hereafter, the subject is collectively referred to as an object for convenience of description.

The memory 130 may store data required for various embodiments.

The memory 130 may be implemented in the form of memory embedded in the display device 100 or in the form of memory detachable from the display device 100 depending on a data storage purpose. For example, in the case of data for driving the display device 100, the data may be stored in the memory embedded in the display device 100, and in the case of data for an expansion function of the display device 100, the data may be stored in memory detachable from the display device 100. Meanwhile, the memory embedded in the display device 100 may be implemented in the form of at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)). Additionally, the memory detachable from the display device 100 may be implemented in the form of a memory card (e.g., a compact flash (CF), a secure digital (SD), a micro secure digital (Micro-SD), a mini secure digital (Mini-SD), an extreme digital (xD), a multi-media card (MMC), and the like), external memory connectable to a USB port (e.g., USB memory), or the like.

As one example, the memory 130 may store a computer program including at least one instruction or instructions that are executed by the one or more processors individually or collectively for controlling the display device 100.

As one example, the memory 130 may store an image received from an external device (e.g., a source device), an external storage medium (e.g., a USB), an external server (e.g., webhard) and the like, i.e., an input image. Alternatively, the memory 130 may store an image (or depth information) acquired through the depth camera 120 provided in the display device 100. Herein, the image may be a 2D video, but is not limited thereto.

As one example, the memory 130 may store various types of information needed for image processing, e.g., information for performing at least one of noise reduction, detail enhancement, tone mapping, contrast enhancement, color enhancement or frame rate conversion, an algorithm, an image quality parameter and the like. Additionally, the memory 130 may also store an intermediate image generated based on image processing, an image generated based on depth information.

According to one or more embodiments, the memory 130 may be implemented in the form of single memory storing data generated in various operations according to the disclosure. However, according to another one or more embodiments, the memory 130 may also be implemented to include a plurality of memories storing different types of data respectively, or storing data generated in different steps respectively.

Further, the memory 130 may store various types of data, programs or applications for driving/controlling the display device 100. In addition, the memory 130 may include a user sensing module, a communication control module, a voice recognition module, a motion recognition module, a light receiving module, a display control module, an audio control module, an external input control module, a power control module, a voice database (DB), or a motion DB.

In the above-described embodiment, storing various types of data in external memory 130 of the processor 140 is described, but at least part of the above-described data may also be stored in the internal memory of the processor 140 depending on an embodiment of at least one of the display device 100 or the processor 140.

The one or more processors 140 may be comprised of one processor or a plurality of processors.

The one or more processors 140 may execute at least one instruction stored in the memory 130 to perform operations of the display device 100 according to embodiments.

The one or more processors 140 may include one or more of a central processing unit (CPU), a graphics processing unit (GPU), an accelerated processing unit (APU), Many Integrated Core (MIC), a digital signal processor (DSP), a neural processing unit (NPU), a hardware accelerator or a machine learning accelerator. The one or more processors 140 may control one among other elements of an electronic apparatus or any combination thereof, and perform an operation in association with communication or data processing. The one or more processors 140 may execute one or more programs or instructions stored in the memory. For example, the one or more processors may execute one or more instructions stored in the memory to perform a method according to one or more embodiments of the disclosure.

In the case where the method according to one or more embodiments includes a plurality of operations, the plurality of operations may be performed by one processor, or by a plurality of processors. For example, when a first operation, a second operation, and a third operation are performed based on the method according to one or more embodiments, the first operation, the second operation and the third operation may all be performed by a first processor, or the first operation and the second operation may be performed by the first processor (e.g., a general-purpose processor), while the third operation may be performed by a second processor (e.g., an AI-exclusive processor).

The one or more processors 140 may be implemented as a single core processor including one core, or one or more multicore processors including a plurality of cores (e.g., homogeneous multi cores or heterogeneous multi cores). In the case where the one or more processors 140 are implemented as a multicore processor, each of the plurality of cores included in the multicore processor may include processor internal memory such as cache memory, and on-chip memory, and common cache shared by the plurality of cores may be included in the multicore processor. Additionally, each of the plurality of cores (or a part of the plurality of cores) included in the multicore processor may read and perform a program instruction for implementing the method according to one or more embodiments independently or in the way that all (or part) of the plurality of cores are linked.

In the case where the method according to one or more embodiments includes a plurality of operations, the plurality of operations may be performed by one of the plurality of cores or performed by the plurality of cores included in the multicore processor. For example, when a first operation, a second operation, and a third operation are performed based on the method according to one or more embodiments, the first operation, the second operation and the third operation may all be performed by a first core included in the multicore processor, or the first operation and the second operation may be performed by the first core included in the multicore processor, while the third operation may be performed by a second core included in the multicore processor.

In the embodiments of the disclosure, the processor may mean a system on a chip (SoC) where one or more processors and other electronic components are integrated, a single core processor, a multicore processor, or a core included in a single core processor or a multicore processor, and herein, the core may be implemented as a CPU, a GPU, an APU, an MIC, a DSP, an NPU, a hardware accelerator, or a machine learning accelerator, or the like, but embodiments of the core may not be limited thereto.

The one or more processors 140 may obtain depth information from an input image. Herein, the input image may be received from the depth camera 120 or an external device. The input image may include a still image, a plurality of still images (or frames) in sequence, or a video. For example, the input image may be a 2D image. Herein, the depth information may be formed into a depth map. The depth map means a table including depth information with respect to each area of the image. The area may be divided based on a pixel unit, or may be defined as a predetermined area greater than the pixel unit. As one example, in the depth map, under the assumption that among gray-scale values of 0-225, 127 or 128 is a reference value, i.e., 0 (or a focal plane), a value less than 127 or 128 may be expressed as a − value, while a value greater than 127 or 128 may be expressed as a + value. Any value between 0-255 may be selected as a reference value of the focal plane. Herein, the − value means subsidence, while the + value means protrusion. However, the values are described merely as an example, and in the depth map, depth may be expressed as various values according to various standards.

As one example, the processor 140 may image-process an input image, and then obtain depth information based on the image-processed image. Herein, the image processing may be digital image processing including at least one of image enhancement, image restoration, image transformation, image analysis, image understanding, image compression, image decoding or scaling.

As one example, the one or more processors 140 may perform various types of pre-processing before obtaining depth information on an input image, but hereafter, an input image and a pre-processed image are referred to as an image for convenience of description, without being categorized.

The one or more processors 140 of one example in the disclosure may obtain an image including an object through the depth camera, and obtain shape information of the object through the obtained image.

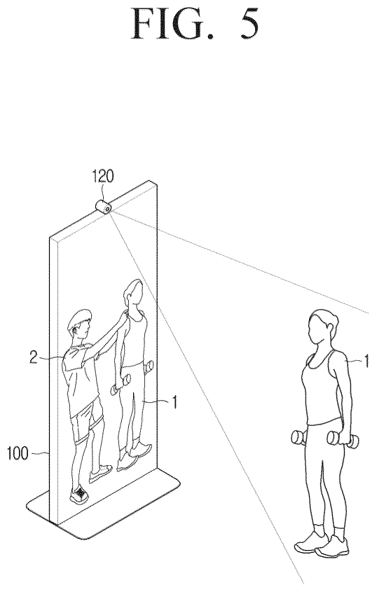

FIG. 5 is a view provided to explain a display device providing an object and a virtual object according to one or more embodiments.

Referring to FIG. 5, the display device 100 of one example in the disclosure may provide a mirror function and a display function.

As one example, the display device 100 may reflect a user placed in front of the display device 100 based on the mirror function to provide an object 1, and display a virtual object 2 based on the display function.

As one example, the object 1 may be placed in the same space (e.g., in front of the mirror display 110) as the space where the display device 100 is placed and correspond to an object (thing) or a user reflected by the mirror display 110, and the virtual object 2 may correspond to an object or a user, or a nonexistent graphic object placed in a different space from the space where the display device 100 is placed.

As one example, an image obtained through the depth camera 120 may be a 2D image, and in the case where the one or more processors 140 identify the object 1 only as a 2D object based on the 2D image, the display device 100 may not provide an interaction between the object 1 and the virtual object 2.

Herein, the interaction may include whether a collision (or contact) occurs between the object 1 and the virtual object 2 based on the shape of the object 1 and the shape of the virtual object 2, whether any one of the object 1 and the virtual object 2 overlaps the other, or a disposition relationship (or an arrangement order) between the object 1 and the virtual object 2 based on a first distance between the object 1 and the display device 100 and a second distance between the virtual object 2 and the display device 100, or the like.

For example, in the case where the one or more processors 140 identify the object 1 only as a 2D object, there may be a problem that an interaction between the object 1 and the virtual object 2 considering the depth information of the object 1 from another viewpoint excluding a viewpoint through the depth camera 120 cannot be provided.

For example, the one or more processors 140 may identify the shape (or surface) of the object 1 from another viewpoint excluding a viewpoint through the depth camera 120, identify whether a collision (or contact) occurs between the object 1 and the virtual object 2 based on the shape of the object 1, and provide no feedback (e.g., vibrations) caused by the occurrence of the collision and the like.

The one or more processors 140 of one example in the disclosure may obtain an image including an object 1 through the depth camera 120, and obtain shape information of the object 1 through the image. The one or more processors 140 of one example may provide an interaction between the object 1 and a virtual object 2 properly by using the shape information of the object 1. Herein, the shape information of the object 1 may include surface information of the object 1.

The one or more processors 140 of one example may obtain a captured image of an object 1 reflected on the mirror display 110 through the depth camera 120, and based on the image, may obtain depth information of the object 1.

The one or more processors 140 of one example may obtain skeleton information of the object 1 based on the depth information, and based on the skeleton information, obtain shape information of thee object 1.

Herein, the shape information of the object 1 may include depth information corresponding to each of a plurality of viewpoints with respect to the object 1, which enables an expression of the object 1 as a 3D object.

The one or more processors 140 of one example may match the virtual object 2 with the object 1 based on the shape information of the object 1 and the shape information of the virtual object 2 to provide the matched objects through the mirror display 110.

As one example, the one or more processors 140 may determine whether a part of the virtual object 2 touches (or collides with or contacts) the object 1 based on the shape information of the object 1 and the shape information of the virtual object 2, and render the virtual object 2 such that a part of the virtual object 2 touches the object 1.

That is, the one or more processors 140 may render the virtual object 2 in the way that a part of the virtual object 2 contacts the object 1 based on the shape information of the object 1, such that the virtual object 2 does not overlap the object 1 (the virtual object 2 is not overlapped with the object 1).

For example, the one or more processors 140 may display the virtual object 2 in the way that the virtual object 2 is placed in the same space as the space where the display device 100 is placed, and displayed like an image reflected by the mirror display 110.

Hereafter, the configuration of rendering the virtual object 2 by the one or more processors 140 based on the shape information of the object 1 and the shape information of the virtual object 2 is referred to as a configuration of matching (adjusting, aligning) the virtual object 2 to the object 1 for convenience of description.

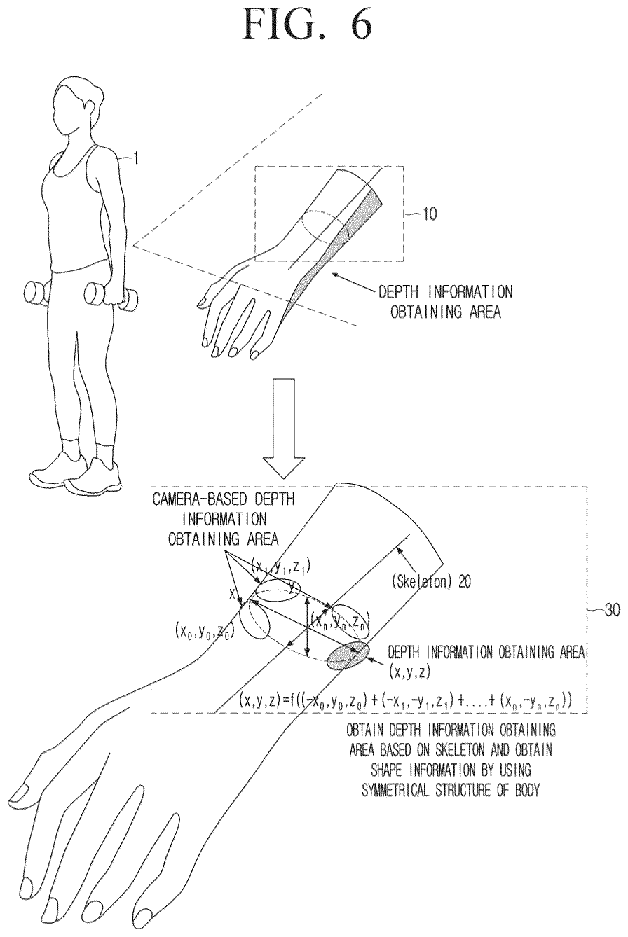

FIG. 6 is a view provided to explain depth information according to one or more embodiments.

An image obtained through a depth camera 120 is a 2D image, and one or more processors 140 can only obtain depth information 10 corresponding to a viewpoint of the depth camera 120 based on the 2D image, but cannot obtain shape information of an object 1 including depth information corresponding to each of a plurality of viewpoints with respect to the object 1.

The one or more processors 140 according to one or more embodiments may obtain depth information 10 of an object 1 based on an image obtained through a depth camera 120.

The one or more processors 140 of one example may obtain skeleton information 20 of the object 1 based on the depth information 10.

The one or more processors 140 of one example may estimate the shape of the object 1 as a symmetrical (or cylindrical) structure with respect to a skeleton (a bone, a frame) to obtain shape information 30 of the object 1.

As one example, the one or more processors 140 may divide the object 1 into a plurality of portions based on the depth information 10, and identify the skeleton of each of the plurality of portions. For example, the one or more processors 140 may identify the central axis of each of the plurality of portions as a skeleton. Then the one or more processors 140 may identify (or estimate) the shape of each of the plurality of portions based on the symmetrical (or cylindrical) structure with respect to the skeleton of each of the plurality of portions.

The one or more processors 140 of one example may obtain the shape information 30 of the object 1 including the shape of each of the plurality of portions.

Referring to FIG. 6, the one or more processors 140 may obtain skeleton information 20 based on depth information 10 of an arm portion, and identify the shape of the arm portion based on a symmetrical structure with respect to a skeleton according to Formula 1 (1) described hereafter:

$$( x , y , z ) = \frac{( - {x}_{0} , {y}_{0} , {z}_{0} ) + ( - {x}_{1} , - {y}_{1} , {z}_{1} ) + … + ( {x}_{n} , - {y}_{n} , {z}_{n} )}{n} \qquad ( 1 )$$

Herein, (x, y, z) means depth information of an object 1 (or depth information of a shadow area of an object 1), (x₀ to xₙ), (y₀ to yₙ), (z₀ to zₙ)), obtained based on an image from another viewpoint (e.g., in a shadow area) excluding a viewpoint of the depth camera 120.

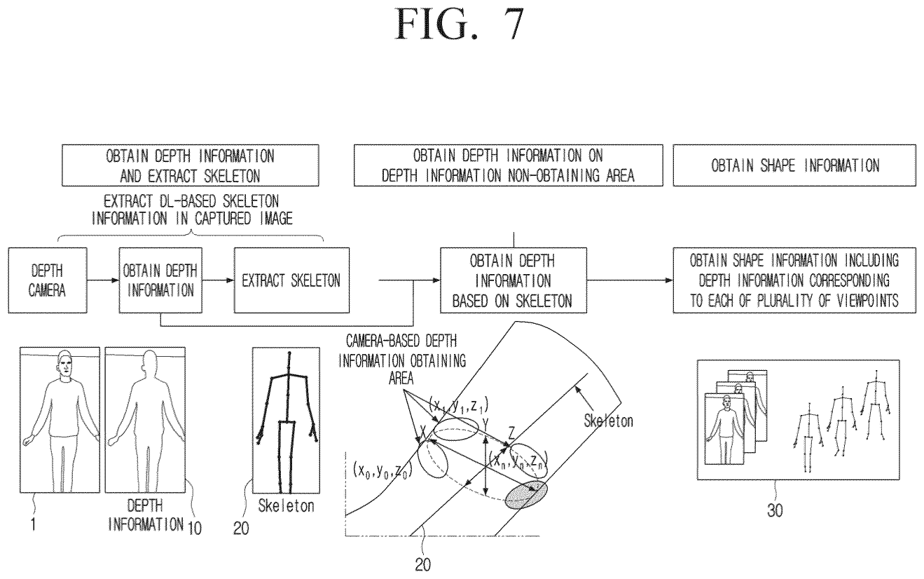

FIG. 7 is a view provided to explain a display device obtaining shape information based on skeleton information according to one or more embodiments.

Referring to FIG. 7, the one or more processors 140 of one example may input an image including an object 1 or depth information 10 to a first neural network model to obtain skeleton information 20. As one example, the skeleton information 20 may include a skeleton of each of a plurality of portions included in the object 1.

The one or more processors 140 of one example may identify the shape of each of the plurality of portions based on a symmetrical structure with respect to the skeleton of each of the plurality of portions included in the skeleton information 20 obtained from the first neural network model.

The one or more processors 140 of one example may obtain shape information 30 of the object 1 including the shape of each of the plurality of portions.

A first neural network model of one example may be a model trained to output skeleton information 20 corresponding to an image as the image is input, by using a plurality of sample images and skeleton information corresponding to each of the plurality of sample images.

As one example, the first neural network model may be a model trained to identify, as an image is input, an object included in the image, identify a plurality of portions included in the object, and identify a skeleton of each of the plurality of portions.

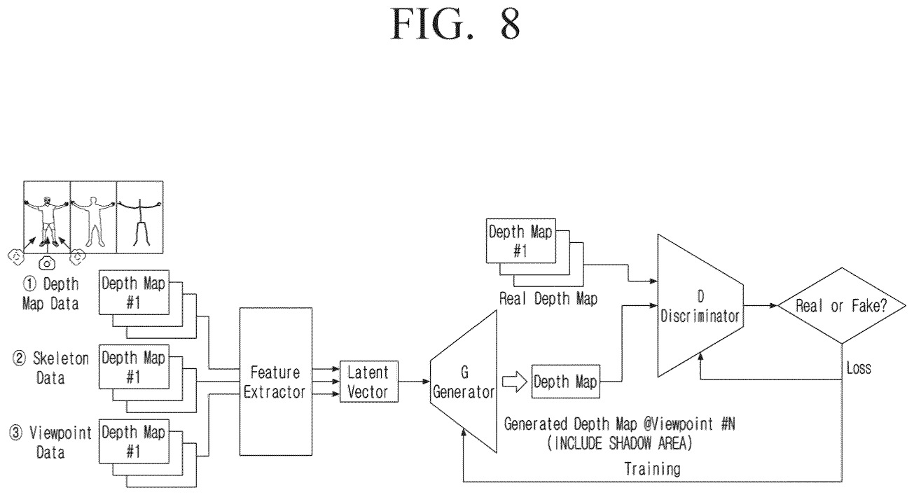

FIG. 8 is a view provided to explain a neural network model obtaining shape information according to one or more embodiments.

The one or more processors 140 of one example in the disclosure may also input an image obtained through the depth camera 120 to a second neural network model to obtain shape information 30 of an object included in the image.

A second neural network model of one example in the disclosure may be a Generative Adversarial Network (GAN)-based model. GAN is comprised of a generator G generating a virtual data sample and a discriminator D discriminating whether an input data sample is actual data. GAN means a machine learning model established based on adversarial training between the generator and the discriminator. The generator G (hereafter, a second neural network model) is a model trained to minimize a difference (loss) between shape information 30 (i.e., depth information corresponding to each of a plurality of viewpoints) generated (or estimated) by the generator and an actual shape of an object 1. The discriminator D is a model identifying a difference value between shape information 30 of an object 1 and an actual shape of the object 1.

However, the above second neural network model is described as one example, and the second neural network model may be a Neural Radiance Field (NeRF)-based model.

The NeRF-based model of one example may be a view synthesis model generating, based on an image obtained by image-capturing an object 1, an image including the object 1 from a new viewpoint (i.e., another viewpoint excluding a viewpoint of the depth camera 120).

For example, a display device 100 may include at least one or more depth cameras 120, and based on at least one or more 2D images where an object 1 is a subject through the at least one or more depth cameras 120, the NeRF-based model may generate, based on the at least one or more 2D images, an image including the object 1 or a 3D object corresponding to the object 1 from a new viewpoint.

As 5D data including (x, y, z) as position information (a spatial location) of an object (or a subject) and (θ, Φ) as a direction (viewing direction) in which an object is viewed (e.g., a viewpoint of the depth camera 120) are input, the NeRF-based model of one example may be a model learning (training) a fully-connected (FC) network estimating a RGB value and the density of an object. Herein, the density of an object is a reciprocal of transparency, and as density is increased, an object becomes opaque (another object behind an object is not seen based on a disposition relationship (or an arrangement order), and as density is decreased, an object becomes transparent.

An artificial intelligence-relating function according to the disclosure may be performed through one or more processors 140 and memory 130 of the display device 100.

The one or more processors 140 may include at least one of a CPU, a GPU, or an NPU, but not be limited to the above examples thereof.

The CPU, as a generic-purpose processor capable of performing an AI computation as well as a normal computation, may efficiently execute a complex program through a multi-level cache structure. The CPU is advantageous in a series processing method enabling an organic connection between previous calculation results and following calculation results based on a consecutive calculation. The generic-purpose processor is not limited to the above examples, unless explicitly indicated as the above-described CPU.

The GPU, as a processor for a massive computation such as a floating-point computation and the like used to process graphics, may perform a massive computation in parallel by integrating cores in massive amounts. In particular, the GPU may have an advantage over the CPU in a parallel processing method such as a convolution computation and the like. Additionally, the GPU may be used as a co-processor for complementing a function of the CPU. A processor for a massive computation is not limited to the above examples, unless explicitly indicated as the above-described GPU.

The NPU, as a processor specializing in an artificial intelligence computation using an artificial neural network, may be implemented in the way that each layer constituting an artificial neural network is implemented with hardware (e.g., silicon). At this time, since the NPU is designed specially according to specifications required by a business, a freedom degree of the NPU is less than that of the CPU or the GPU, but the NPU may process an artificial intelligence computation required by a business efficiently. Meanwhile, as a processor specializing in an artificial intelligence computation, the NPU may be implemented in various forms such as a tensor processing unit (TPU), an intelligence processing unit (IPU), a vision processing unit (VPU) and the like. An artificial intelligence processor is not limited to the above examples, unless explicitly indicated as the above-described NPU.

Additionally, the one or more processors 140 may be implemented as a SoC. At this time, memory, and a network interface such as a bus and the like for data communication between a processor and memory may be further included, in addition to one processor or a plurality of processors in the SoC.

In the case where a plurality of processors is included in a SoC included in the display device 100, the display device 100 may perform an artificial intelligence-relating computation (e.g., a computation associated with learning or inference of an artificial intelligence model) by using a part of the plurality of processors. For example, the display device 100 may perform an artificial intelligence-relating computation by using at least one of a GPU, an NPU, a VPU, a TPU, or a hardware accelerator specializing in an artificial intelligence computation such as a convolution computation, a matrix multiplication computation and the like, among the plurality of processors. However, this is provided merely as one embodiment, and certainly, an artificial intelligence-relating computation may be processed by using the CPU and the like and a generic-purpose processor.

Additionally, the display device 100 may perform a computation associated with an artificial intelligence-relating function by using a multi core (e.g., a dual core, a quad core and the like) included in one processor. In particular, the display device 100 may perform an artificial intelligence computation such as a convolution computation, a matrix multiplication computation and the like in parallel by using a multi core included in the processor.

The one or more processors 140 may perform control to process input data, according to a predefined operation rule or an artificial intelligence model (or a neural network model or a learning network) that is stored in the memory 130. The predefined operation rule or the artificial intelligence model is characterized in that the predefined operation rule or the artificial intelligence model is made through learning.

Herein, making the predefined operation rule or the artificial intelligence model through learning means making a predefined operation rule or an artificial intelligence model of a desired feature, by applying a learning algorithm to large numbers of learning data. Such learning may be performed in a device itself in which artificial intelligence according to the disclosure is performed, or performed through a separate server/system.

The artificial intelligence model may be comprised of a plurality of neural network layers. At least one layer has at least one weight value, and a computation of layer is performed through results of a computation of a previous layer and at least one defined computation. Examples of the neural network may include a convolutional neural network (CNN), a deep neural network (DNN), a recurrent neural network (RNN), a restricted boltzmann machine (RBM), a deep belief network (DBN), a bidirectional recurrent deep neural network (BRDNN), a generative adversarial network (GAN), a NeRF and a deep Q-network, a transformer, but the neural network in the disclosure is not limited to the above examples, unless explicitly stated otherwise.

The learning algorithm is a method by which a predetermined target device (e.g., a robot) is trained by using large numbers of learning data, to enable the predetermined target device to make its own decision or prediction. Examples of the learning algorithm may include supervised learning, unsupervised learning, semi-supervised learning or reinforcement learning, but the learning algorithm in the disclosure is not limited to the above example, unless explicitly stated otherwise.

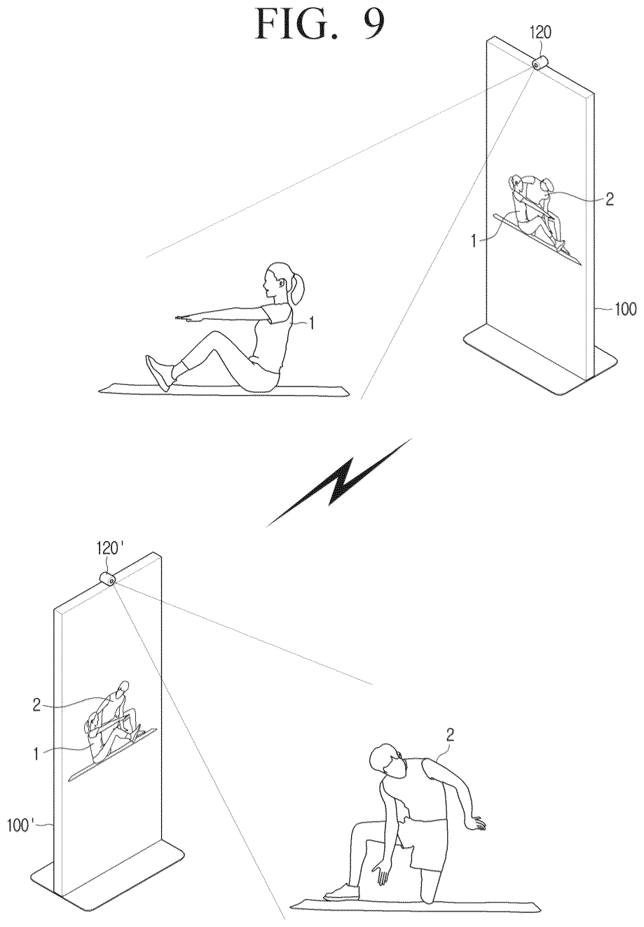

FIG. 9 is a view provided to explain a display device communicating with an external device according to one or more embodiments.

The display device 100 of one example may further include a communication interface, and communicate with another display device (hereafter, an external device 100′) through the communication interface.

The communication interface may certainly be implemented as various types of interfaces depending on an embodiment of the display device 100. For example, the communication interface may perform communication with an external device 100′, an external storage medium (e.g., USB memory), or an external server (e.g., webhard) and the like, based on a communication method such as Bluetooth, AP-based Wi-Fi (Wi-Fi, Wireless LAN network), Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like. As one example, the communication interface may perform communication with another electronic apparatus, an external server and/or a remote control device and the like.

In particular, as one example, the one or more processors 140 may transmit shape information of an object 1 to an external device 100′, and receive shape information of a virtual object 2 from the external device 100′.

As one example, the external device 100′ may obtain shape information of a user placed in the same space as the space where the external device 100′ is placed and reflected by a mirror display 110′ provided at the external device 100′. Then, the external device 100′ may transmit the shape information of the user (or an object (a thing) and the like) to the display device 100. For convenience of description, the user reflected by the mirror display 110′ provided at the external device 100′ is collectively referred to as a virtual object 2.

The one or more processors 140 may control the mirror display 110 to display the virtual object 2 based on the shape information of the virtual object 2 received from the external device 100′.

The one or more processors 140 of one example may match and display the virtual object 2 to the object 1 based on the shape information of the object 1 and the shape information of the virtual object 2.

As one example, the one or more processors 140 may identify a first distance between the object 1 and the display device 100 based on the shape information of the object 1. The one or more processors 140 may identify a second distance between the virtual object 2 and the display device 100 based on the shape information of the virtual object 2.

The one or more processors 140 of one example may place any one of the object 1 and the virtual object 2 based on the first distance and the second distance further rearward than the other.

As one example, the one or more processors 140 may place at least one portion (or a part of the virtual object 2) of a plurality of portions included in the virtual object 2 further forward than the object 1, while placing the remaining portion (or the remainder of the virtual object 2) further rearward than the object 1.

Meanwhile, the one or more processors 140 may transmit the shape information of the object 1 to the external device 100′, and certainly, the external device 100′ may match the object 1 to the virtual object 2 and provide the matched objects through the mirror display 110′ based on the shape information of the object 1 and the shape information of the virtual object 2.

The one or more processors 140 of one example may display the virtual object 2 in the way that a part of the virtual object 2 contacts the object 1 on the mirror display 110 based on the shape information of the object 1 and the shape information of the virtual object 2.

For example, the one or more processors 140 may identify the object 1 and the virtual object 2 respectively as a 3D object rather than a 2D object, and display the virtual object 2 in the way that a part of the virtual object 2 contacts the object 1 based on surface information of the object 1, without overlapping the object 1 and the virtual object 2 (or without displaying the virtual object 2 in the way that the virtual object 2 passes through or penetrates the object 1).

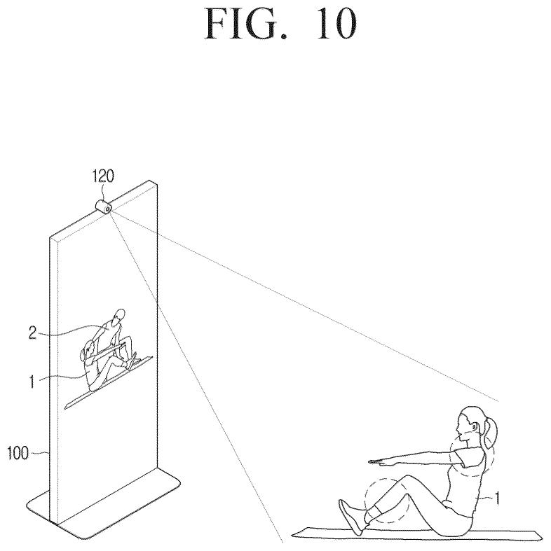

FIG. 10 is a view provided to explain a virtual object matched to an object according to one or more embodiments.

Referring to FIG. 10, the one or more processors 140 may match (or adjust) the virtual object 2 to the object 1 and display the matched objects based on the shape information of the object 1 and the shape information of the virtual object 2 received from the external device 100′, instead of displaying the object 1 and the virtual object 2 in the way that the virtual object 2 covers the object 1 reflected by the mirror display 110 over without an adjustment.

For example, the one or more processors 140 may obtain a 3D object corresponding to the object 1 based on depth information corresponding to each of a plurality of viewpoints with respect to the object 1 included in the shape information of the object 1. The 3D object may also include pose information of the object 1.

As one example, the one or more processors 140 may obtain a 3D object corresponding to the virtual object 2 based on the shape information of the virtual object 2.

As one example, the one or more processors 140 may identify whether contact occurs based on the pose of the object 1 and the pose of the virtual object 2 from a new viewpoint (or in an area with no depth information obtained through the depth camera 120), excluding a viewpoint based on the depth camera 120.

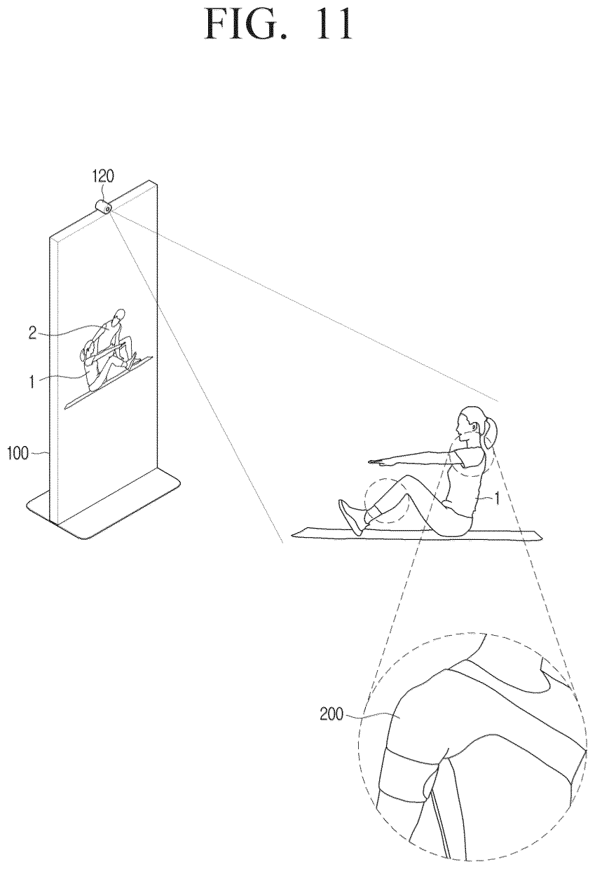

FIG. 11 is a view provided to explain a display device providing a feedback according to one or more embodiments.

The one or more processors 140 of one example in the disclosure may communicate with a wearable device 200 through the communication interface. Herein, the wearable device 200 means a device that is formed of a flexible material (e.g., silicone, rubber, fiber and the like), and is worn by a user or touchable by a part of the body of a user. For example, the wearable device 200 may include various types of devices such as a watch, clothes (e.g., a haptic suit), shoes, gloves, glasses, a hat, accessories (e.g., a ring) and the like that are worn by a human or an animal. However, these are described merely as examples, and certainly, the wearable device is not limited to the above examples.

Based on contact between a part of the virtual object 2 and the object 1 being identified on the mirror display 110, the one or more processors 140 of one example may control the wearable device 200 to provide a tactile feedback to an area contacted by a part of the virtual object 2, on the object 1.

For example, as illustrated in FIG. 11, based on changed shape information of the virtual object 2 being received from the external device 100′ according to movement of another user expressed as the virtual object 2 while the user (i.e., an object 1) is wearing a wearable device 200 in the shoulder portion, the one or more processors may match the virtual object 2 to the object 1 again based on the changed shape information of the virtual object 2. As one example, as a part of the virtual object 2 contacts a shoulder portion of the object 1, the one or more processors 140 may transmit a control signal to the wearable device 200 to provide a feedback (e.g., vibrations) to the shoulder portion of the user.

As one example, as the pose of a user (i.e., a user different from a user using the display device 100) using an external device 100′ is changed, a depth camera 120′ of the external device 100′ may obtain an image including the user with a changed pose, and obtain changed shape information of the user (hereafter, a virtual object 2).

As one example, the external device 100′ may transmit the changed shape information to the display device 100, and the one or more processors 140 may match the virtual object 2 to the object 1 again based on the changed shape information.

As one example, the virtual object 2 is matched to the object 1 again based on the changed shape information of the virtual object 2 in real time or at predetermined time intervals, such that the display device 100 may provide the effect of allowing the user of the display device 100 to feel like the user (i.e., another user) of the external device 100′ is placed in the same space as the space where the user of the display device 100 is placed and another user is reflected on the mirror display 110 of the display device 100.

Additionally, the display device 100 may further include a speaker, and a microphone provided at an external device 100′ may obtain a voice of another user, a sound occurring in a space where the external device 100′ is placed and the like, and transmit the voice and sound to the display device 100, such that the display device 100 outputs the voice and sound received from the external device 100′. Additionally, the display device 100 may further include a microphone, and the microphone provided at the display device 100 may obtain a voice of the user, a sound occurring in a space where the display device 100 is placed and the like, and transmit the voice and sound to an external device 100′, such that the external device 100′ outputs the voice and the sound received from the display device 100.

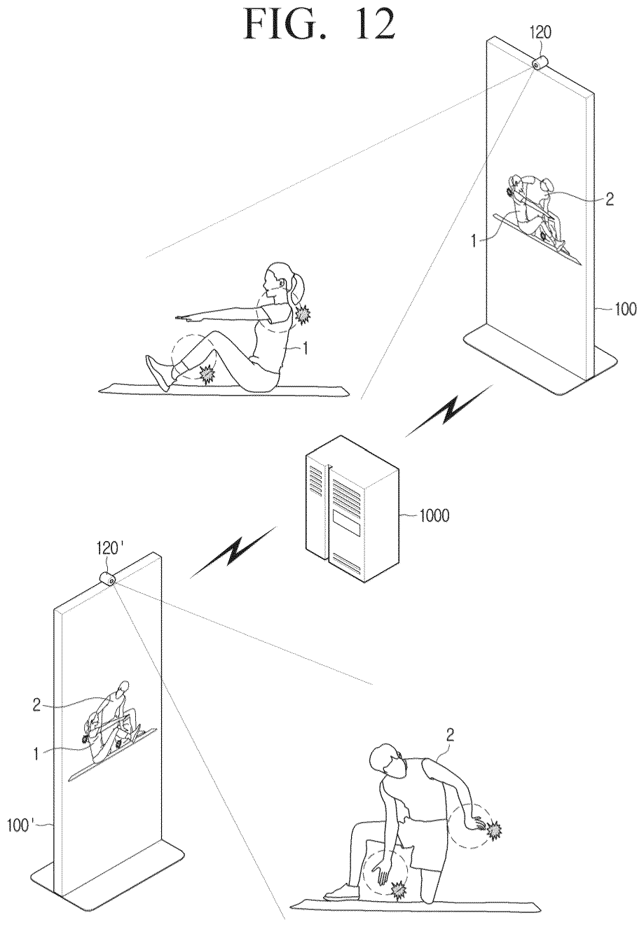

FIG. 12 is a view provided to explain a display device communicating with an external device according to one or more embodiments.

As one example, the display device 100 and an external device 100′ may also communicate with each other through an external server 1000.

As one example, based on an input of a user with respect to a virtual object 2 being identified, the one or more processors 140 may interact with the virtual object 2.

For example, based on identifying that an object 1 reflected on the mirror display 110 touches a virtual object 2 or identifying contact between an object 1 and a virtual object 2 according to a change in the pose of a user, the one or more processors 140 may interact with the virtual object 2.

For example, in the case where the virtual object 2 is a graphic object, the one or more processors 140 may execute an operation (or a function) corresponding to the graphic object.

For example, in the case where the virtual object 2 corresponds to the user of the external device 100′, the one or more processors 140 may transmit, to the external device 100′, a signal for controlling a wearable device worn by the user using the external device 100′ to allow the wearable device to provide a tactile feedback, and the external device 100′ may control the wearable device worn by the user using the external device 100′ based on the received signal.

For example, the one or more processors 140 may adjust at least one of the position, viewpoint, size or ratio of the virtual object 2 on the mirror display 110 based on an input of the user with respect to the virtual object 2.

As one example, in the case where the input of the user is an input of rotating the virtual object 2, the one or more processors 140 may change the viewpoint of the virtual object 2 (or rotate the virtual object 2) based on shape information of the virtual object 2.

As one example, in the case where the input of the user is an input of changing an arrangement order of the virtual object 2, the one or more processors 140 may place the virtual object 2 in front of or behind the object 1 based on the input of the user.

As one example, in the case where the input of the user is an input of changing the size of the virtual object 2 (e.g., a pinch of decreasing a size, a spread of increasing a size, and the like), the one or more processors 140 may change the size of the virtual object 2 based on the input of the user.

Herein, the input of the user may include a touch input with respect to the mirror display 110 (i.e., an input causing physically contact the mirror display 110), an input through an object 1 reflected on the mirror display 110 corresponding to a changed pose of the user (i.e., an input causing no physical contact with the mirror display 110), and the like. For example, the one or more processors 140 may identify a hand portion (e.g., a thumb and an index finger and the like) from the object 1 reflected on the mirror display 110, and identify an input based on the pose, position, shape and the like of the identified hand portion.

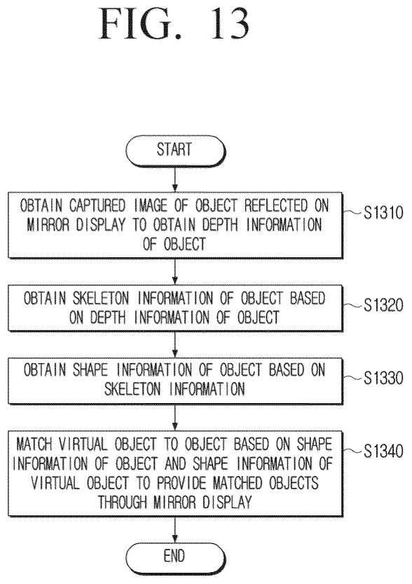

FIG. 13 is a flowchart provided to explain a control method of a display device according to one or more embodiments.

A control method of one example includes obtaining an image where an object reflected on a mirror display is captured, to obtain depth information of the object (step S1310).

The method includes obtaining skeleton information of the object based on the depth information of the object (step S1320).

The method includes obtaining shape information of the object based on the obtained skeleton information (step S1330).

The method includes matching a virtual object to the object and providing the matched objects through the mirror display based on the shape information of the object and shape information of the virtual object (step S1340).

The skeleton information of the object of one example may include a skeleton of each of a plurality of portions included in the object, and step S1330 of obtaining shape information may include identifying the shape of each of the plurality of portions based on a symmetrical structure with respect to the skeleton of each of the plurality of portions and obtaining shape information of the object including the shape of each of the plurality of portions.

Step 1330 of obtaining shape information of one example may include inputting the image to a neural network model to obtain shape information of the object included in the image, and based on the image including the object being input, the neural network model may be a model trained to output the shape information of the object including depth information corresponding to each of a plurality of viewpoints with respect to the object from the depth information of the object.

Step 1340 of providing the matched objects of one example may include placing a part of the virtual object in front of the object and placing the remainder of the virtual object behind the object, based on the shape information of the object and the shape information of the virtual object, to display the virtual object.

Step 1340 of providing the matched objects of one example may include displaying the virtual object in the way that a part of the virtual object contacts the object on the mirror display based on the shape information of the object and the shape information of the virtual object.

The control method of the disclosure may further include, based on contact between a part of the virtual object and the object being identified on the mirror display, controlling a wearable device worn by the object to provide a tactile feedback to an area contacted by a part of the virtual object, on the object.

The control method of the disclosure may further include receiving the shape information of the virtual object from an external device and transmitting the shape information of the object to the external device.

The control method of the disclosure may further include, based an input of a user with respect to the virtual object being identified, performing an interaction with the virtual object according to the input, and the transmitting the shape information of the object to the external device may include transmitting changed shape information of the object based on the input of the user to the external device, and the input of the user may include a touch input with respect to a part of the virtual object.

Step 1340 of providing the matched objects of one example may include, based on changed shape information of the virtual object being received from the eternal device according to an input of another user with respect to the object, matching the virtual object to the object again based on the changed shaped information, and the virtual object may correspond to another user reflected on the mirror display provided at the external device, while the object may correspond to the user.

The control method of one example may further include adjusting at least one of the position, viewpoint, size or ratio of the virtual object on the mirror display based on an input of the user.

However, the embodiments of the disclosure may certainly be applied to various types of electronic apparatuses including a mirror function and a display function as well as a display device.

Meanwhile, the embodiments described above may be implemented in a recording medium readable by a computer or a device similar to a computer by using software, hardware or a combination thereof. In some cases, the embodiments set forth herein may be implemented as a processor itself. In the case of software implementation, the embodiments such as steps and functions described herein may be implemented as separate software modules. Each of the software modules may perform one or more functions and operations set forth herein.

Meanwhile, computer instructions for performing processing operations of the display device 100 according to the embodiments described above may be stored in a non-transitory computer-readable medium. The computer instructions stored in the non-transitory computer-readable medium, when executed by a processor of a specific device, cause the specific device to perform the processing operations in the display device 100 according to the embodiments described above.

The non-transitory computer-readable medium means a medium that stores data semi-permanently and is readable by a machine, rather than a medium such as a register, cache, and memory and the like that store data temporarily. Specific examples of the non-transitory computer-readable medium may include a CD, a DVD, a hard disc, a blue-ray disc, a USB, a memory card, and ROM and the like.

While the example embodiments of the disclosure are illustrated and described above, embodiments of the disclosure are not limited to the embodiments set forth herein, and certainly, various modifications thereof may be made by those skilled in the art to which the disclosure pertains, without departing from the gist of the disclosure claimed in the section of claims, and are not to be understood as separating from the technical spirit or prospect of the disclosure.

What is claimed is:

1. A display device comprising:
a mirror display;
a depth camera configured to capture an image of an object reflected on the mirror display;
memory storing instructions; and
one or more processors,
wherein the instructions, when executed by the one or more processors individually or collectively, cause the display device to:
obtain the image of the object through the depth camera and obtain depth information of the object, obtain, based on the depth information of the object, skeleton information of the object,
obtain, based on the skeleton information, shape information of the object, and
match, based on the shape information of the object and virtual shape information of a virtual object, the virtual object to the object and display the virtual object, as matched to the object, through the mirror display.

2. The display device of claim 1, wherein the skeleton information of the object represents a skeleton of each of a plurality of portions included in the object, and
wherein the instructions, when executed by the one or more processors individually or collectively, cause the display device to:
identify, based on a symmetrical structure with respect to the skeleton of each of the plurality of portions, a shape of each of the plurality of portions, and
obtain the shape information of the object based on obtaining a shape of each of the plurality of portions.

3. The display device of claim 1, wherein the instructions, when executed by the one or more processors individually or collectively, cause the display device to input the image to a neural network model and obtain, from the neural network model, the shape information of the object included in the image, and
wherein the neural network model is a model trained to output, based on the image including the object being input, the shape information of the object as including the depth information and with the depth information corresponding to each of a plurality of viewpoints with respect to the object.

4. The display device of claim 1, wherein the instructions, when executed by the one or more processors individually or collectively, cause the display device to place, in the display of the object and based on the shape information of the object and the virtual shape information of the virtual object, a part of the virtual object in front of the object and a remainder of the virtual object behind the object.

5. The display device of claim 1, wherein the instructions, when executed by the one or more processors individually or collectively, cause the display device to display, based on the shape information of the object and the virtual shape information of the virtual object, the virtual object in a way that a part of the virtual object contacts, in the display as output through the mirror display, the object.

6. The display device of claim 5 further comprising:
a communication interface,
wherein the instructions, when executed by the one or more processors individually or collectively, cause the display device to:
control the communication interface to communicate with a wearable device worn by the object, and
control, based on identifying that the part of the virtual object contacts an area of the object in the display output through the mirror display, the wearable device to provide a tactile feedback to the area of the object.

7. The display device of claim 1 further comprising:
a communication interface;
wherein the instructions, when executed by the one or more processors individually or collectively, cause the display device to:
receive, from an external device and through the communication interface, the virtual shape information of the virtual object, and
control the communication interface to transmit the shape information of the object to the external device.

8. The display device of claim 7, wherein the instructions, when executed by the one or more processors individually or collectively, cause the display device to:
perform, based on an input of a user with respect to the virtual object being identified, an interaction with the virtual object according to the input,
transmit, to the external device and based on the input of the user, changed shape information of the object, and
the input of the user comprises a touch input with respect to a part of the virtual object.

9. The display device of claim 8, wherein the instructions, when executed by the one or more processors individually or collectively, cause the display device to re-match, based on further changed shape information of the virtual object being received from the external device and according to a second input of a second user with respect to the object, the virtual object to the object,
wherein the virtual object corresponds to the second user as reflected on a second mirror display of the external device, and
wherein the object corresponds to the user.

10. The display device of claim 1, wherein the instructions, when executed by the one or more processors individually or collectively, cause the display device to adjust, based on an input of a user, at least one of a position, a viewpoint, a size, or a ratio of the virtual object on the mirror display.

11. A control method of a display device including a mirror display, the control method comprising:
obtaining an image of an object, that is reflected on the mirror display, and depth information of the object;
obtaining, based on the depth information of the object, skeleton information of the object;
obtaining, based on the skeleton information, shape information of the object; and
matching, based on the shape information of the object and virtual shape information of a virtual object, the virtual object to the object and displaying of the virtual object, as matched to the object, through the mirror display.

12. The control method of claim 11, wherein the skeleton information of the object represents a skeleton of each of a plurality of portions included in the object, and
wherein the obtaining the shape information comprises:
identifying, based on a symmetrical structure with respect to the skeleton of each of the plurality of portions, a shape of each of the plurality of portions; and
obtaining the shape information of the object based on obtaining shapes of each of the plurality of portions.

13. The control method of claim 11, wherein the obtaining the shape information comprises inputting the image to a neural network model and obtaining, from the neural network model, the shape information of the object included in the image,
wherein the neural network model is a model trained to output, based on the image including the object being input, the shape information of the object as including the depth information and with the depth information corresponding to each of a plurality of viewpoints with respect to the object.

14. The control method of claim 11, wherein the displaying of the virtual object, as matched to the object, through the mirror display comprises placing, in the display of the object and based on the shape information of the object and the virtual shape information of the virtual object, a part of the virtual object in front of the object and a remainder of the virtual object behind the object.

15. The control method of claim 11, wherein the displaying of the virtual object, as matched to the object, through the mirror display comprises displaying, based on the shape information of the object and the virtual shape information of the virtual object, the virtual object in a way that a part of the virtual object contacts, in the display as output through the mirror display, the object.

16. A non-transitory computer readable medium storing a program configured to cause one or more processors to implement a control method of a display device including a mirror display, the control method comprising:
obtaining an image of an object, that is reflected on the mirror display, and depth information of the object;
obtaining, based on the depth information of the object, skeleton information of the object;
obtaining, based on the skeleton information, shape information of the object; and
matching, based on the shape information of the object and virtual shape information of a virtual object, the virtual object to the object and displaying the virtual object, as matched to the object, through the mirror display.

17. The non-transitory computer readable medium of claim 16, wherein the skeleton information of the object represents a skeleton of each of a plurality of portions included in the object, and
wherein the obtaining the shape information comprises:
identifying, based on a symmetrical structure with respect to the skeleton of each of the plurality of portions, a shape of each of the plurality of portions; and
obtaining the shape information of the object based on obtaining shapes of each of the plurality of portions.

18. The non-transitory computer readable medium of claim 16, wherein the obtaining the shape information comprises inputting the image to a neural network model and obtaining, from the neural network model, the shape information of the object included in the image,
wherein the neural network model is a model trained to output, based on the image including the object being input, the shape information of the object as including the depth information and with the depth information corresponding to each of a plurality of viewpoints with respect to the object.

19. The non-transitory computer readable medium of claim 16, wherein the displaying of the virtual object, as matched to the object, through the mirror display comprises placing, in the display of the object and based on the shape information of the object and the virtual shape information of the virtual object, a part of the virtual object in front of the object and a remainder of the virtual object behind the object.

20. The non-transitory computer readable medium of claim 16, wherein the displaying of the virtual object, as matched to the object, through the mirror display comprises displaying, based on the shape information of the object and the virtual shape information of the virtual object, the virtual object in a way that a part of the virtual object contacts, in the display as output through the mirror display, the object.
